(19) United States
(12) Patent Application Publication
(10) Pub. No.: US 2022/0207049 A1
(43) Pub. Date: Jun. 30, 2022

(54) METHODS, DEVICES AND SYSTEMS FOR PROCESSING AND ANALYSING DATA FROM MULTIPLE SOURCES

(71) Applicant: CyberCube Analytics Inc., San Francisco, CA (US)

(72) Inventor: Mohammad Al-Boni, San Francisco, CA (US)

(21) Appl. No.: 17/137,081

(22) Filed: Dec. 29, 2020

(51) Int. Cl. G06F 16/2457; G06F 16/28; G06F 16/215; G06N 20/00; G06F 16/951; G06F 16/9538; G06F 16/955; G06F 40/284

(52) U.S. Cl. CPC G06F 16/24578; G06F 16/285; G06F 16/215; G06F 40/284; G06F 16/951; G06F 16/9538; G06F 16/955; G06N 20/00

(57) ABSTRACT

Methods, systems, and devices for data processing and/or analysis are provided. In accordance with some embodiments, the method can rank content and include, among other things: obtaining a plurality of content items, obtaining metadata from each of the content items, wherein the metadata comprises at least one classification of the content items, determining a rank of each content item based on at least the obtained metadata of the content item, and transmitting at least a subset of the ranked content items. The systems and devices can be configured to run the method.

### FIELD

The present disclosure relates to determining the occurrence of cyber security incidents based on an analysis of data feeds. More particularity, although not exclusively, the present disclosure provides a technique and system for processing data from multiple sources, including static and dynamic content, to identify and/or extract specific patterns or insights associated with one or more types of cyber-security attacks.

### BACKGROUND

The size of the World Wide Web (or Web) and the Internet have continued to increase since their inception. Not only has the amount of data available increased, but also the type and breadth of data has increased. Methods of publishing these different types of data have also become more diverse.

Further still, the type of content has developed and diversified. From simple text interfaces, to databases, to complex websites, to video content; all are now available to Web users.

A user typically uses a search engine to locate information they are interested in on the Web. Search engines are configured to crawl the publicly visible Web (through use of “spiders”) and index the content.

Search engines also take in specific user keywords they are interested in, compares those keywords the indexed content and then returns a list of results ranked according to relevance to the keywords and other ranking algorithms that are often kept secret from the user.

It is not uncommon for search engines to return thousands upon thousands of results, many more than a user ever would be interested or have time to consume. Further, these irrelevant results may be processed and presented to a user wasting computing resources.

Accordingly, this a need for techniques and systems for improved processing and analysis of data being made available to a user.

### SUMMARY OF THE INVENTION

In a first aspect, there is provided, a computer implemented method for data processing and/or analysis, the method comprising the steps of: obtaining a plurality of content items, obtaining metadata from each of the content items, wherein the metadata comprises at least one classification of the content items, determining a rank of each content item based on at least the obtained metadata of the content item, and transmitting at least a subset of the ranked content items.

In a second aspect, there is provided, a computer implemented method for data processing and/or analysis, the method comprising the steps of: receiving source data, wherein the source data is indicative of at least one content item, obtaining a plurality of content items, filtering content items based on a list of key words, removing duplicate content items, determining a rank of each content item, and transmitting at least a subset of the ranked content items.

In a third aspect, there is provided, a computer implemented method for data processing and/or analysis, the method comprising the steps of: obtaining at least one content item, obtaining metadata associated with at least one content item, providing the metadata to a plurality of users, receiving further metadata from the users, consolidating the further metadata, and updating the metadata with the consolidated further metadata.

In a fourth aspect, there is provided, a computer device configured to run any one or more of the preceding methods as described with reference to any of the preceding aspects.

In a fifth aspect, there is provided, a non-transitory computer readable medium configured to store computer readable instructions, which when executed by one or more processors performs any one or more of the methods as described with reference to any of the preceding computer implemented method aspects.

In a sixth aspect, there is provided, a system comprising at least one data server configured to provide source data indicative of content items, and a content ranking device according the device of the fourth aspect.

Some specific components and embodiments of the disclosed systems and methods are now described by way of illustration with reference to the accompanying drawings, in which like reference numerals refer to like features.

### BRIEF DESCRIPTION OF THE FIGURES

FIG. 1 is a schematic, pictorial illustration of an example non-limiting content classifying and ranking system.

FIG. 2 illustrates an example non-limiting content ranking device for receiving, reading, processing, and providing ranked content.

FIG. 3 illustrates an example non-limiting data server for providing source data and optionally content.

FIG. 4 illustrates an example non-limiting user device for reviewing ranked content.

FIG. 5 illustrates an example non-limiting method of receiving, reading, processing, and providing ranked content.

FIG. 6 illustrates an example non-limiting system for viewing, classifying, ranking and processing content.

FIG. 7 illustrates a further example non-limiting system for viewing, classifying, ranking and processing content.

FIGS. 8A and 8B illustrate example non-limiting systems for providing ranked content and receiving and processing feedback.

FIG. 9 shows a chart of WannaCry mentions in news articles across time.

FIG. 10 illustrates an example non-limiting system for identifying and storing incidents.

FIG. 11 shows a chart showing how logistic regression can be used in a classification model.

### DETAILED DESCRIPTION

The first aspect, as mentioned above, provides a computer implemented method for data processing and/or analysis. The method comprises obtaining a plurality of content items. The method then comprises obtaining metadata from each of the content items, wherein the metadata comprises at least one classification of the content items. In some embodiments, the metadata for each of the content items comprises classifying the content item using at least one classification model. In some embodiments, the at least one classification model is any one or more of the following: an industry model, a size model, incident type model, and a data type model.

The method of the first aspect then comprises determining a rank of each content item based on at least the obtained metadata of the content item.

In some embodiments, the rank is based at least in part on the at least one classification. Related to this, in some embodiments, the at least one classification is any one or more of the following classifications: industry classification, size classification, incident classification, attack type classification, and data type classification.

The method then transmits at least a subset of the ranked content items.

Advantageously, processing a plurality content items into one or more classifications across all sources, and the using the determined classifications to determine a rank ensures that content items from multiple sources can be processed and analysed simultaneously and accurately to achieve the desired or relevant results. Despite the differences in the content items and/or the metadata from the multiple sources, the method of the first aspect can be used to extract and rank items based using the same classifications.

In some embodiments the rank is based at least in part on the age of the content item. In this case, in related embodiments the rank is higher if the content item is newer. This advantageously ensures that current or new content is prioritised over any expired content, even if there are more older items than new items, thereby ensuring the freshness of the overall analysis.

In some embodiments, the classification model used in the first aspect is any one or more of the following: an industry model, a size model, incident type model, and a data type model. In some embodiments, the classification model is a pre-trained machine learning model. Advantageously, using a machine leaning model such as an artificial neural network that is trained based on bags-of-words from relevant tagged and/or ranked content items, domain expert inputs, and/or user feedback, ensures that accuracy as well as constant refinement the model as well as the training thereby increasing the speed and accuracy of the classification function.

The second aspect, as described above, and some embodiments of the first aspect, provide a computer implemented method for data processing and/or analysis comprising obtaining a plurality of content items from a plurality of sources this includes receiving source data, indicative of each content item. The content items are obtained and initially filtered based on a set of key words.

Advantageously, the filtering step is conducted as early on in the process as possible, as this step requires fewer computational resources when compared with the other steps in the pipeline. By filtering early, the more computationally intensive steps simply won't operate on filtered out content items thereby saving computer resources.

The method then removes any duplicates in the content items. Removing duplicates in the content items advantageously saves storage space when saving the content items and bandwidth when sending the content items. It also saves the end user's time as they won't have to read content twice.

As with the first aspect, the second aspect determines a rank of each content item and transmits at least a subset of the content items. Similar advantages as discussed with reference to the first aspect apply to the second aspect.

In some embodiments, each key word in the word list is searching for in the content item. If none of the key words are present in the content item, it is removed from further processing.

Advantageously, the key word list provides single list that a domain expert can update or modify to broaden or narrow the scope of the filtering. Having this in one place and once simple action provides an easily modifiable and adaptable system to limit the amount of data being processed in the following steps.

In some embodiments, the content items are obtained using a reference in the source data. The reference is a URL. In other embodiments, the content items are contained within the source data and extracted from there. In further embodiments, the method comprises the ability to obtain the content item using either method depending on the data source.

Advantageously, being flexible to locate the content item via a reference in the source data or in the source data itself allows the system to take in source data from a greater number of sources. Obtaining content items from a greater number of data sources results in a broader selection of content items for an end user. Given the classification, filtering, and deduplication steps described here, having a greater amount of input data will not result a substantial increase of output content nor an increase of irrelevant, duplicated, or otherwise useless content.

In some embodiments, the step of removing duplicate content items comprises the step of comparing each content item to each other content item and if a content item is similar enough then at least one of the content items is removed from further processing.

In some embodiments, the method further comprises the step of extracting terms using at least one rule-based matcher. Preferably, the at least one rule-based matcher is configured to identify at least one linguistic pattern using a linguistic rule. More preferably, the content item comprises text, the text is tokenized, and the at least one rule-based matcher is configured to operate on the tokens of the text. In some embodiments, the at least one rule-based matcher is configured to match then extract content relating to any one or more of the following: vulnerability, threat-actor, and entity-event. Preferably, the extracted terms are used to filter the content items further.

Advantageously, this provides a further simple, lower computationally intensive (when compared with other steps in these aspects) step to find content relevant to a request.

The third aspect, and in some embodiments of the first and second aspects, the method comprises (or further comprises) the steps of: obtaining at least one content item, obtaining metadata associated with at least one content item, providing the metadata to a plurality of users, receiving further metadata from the users, consolidating the further metadata, and updating the metadata with the consolidated further metadata.

Advantageously, obtaining hand crafted metadata from a plurality of users enables machine learning models described herein to be improved and/or re-trained. Using real-world user data for training results in an improved classification and ranking system and therefore provides more useful and relevant results. Further, the resulting combination of automatically generated metadata with user generated metadata will likely result in an improved classification of the content item thereby improving the ranking system for any future queries. Preferably, the metadata of this embodiment comprises classifications of the content item.

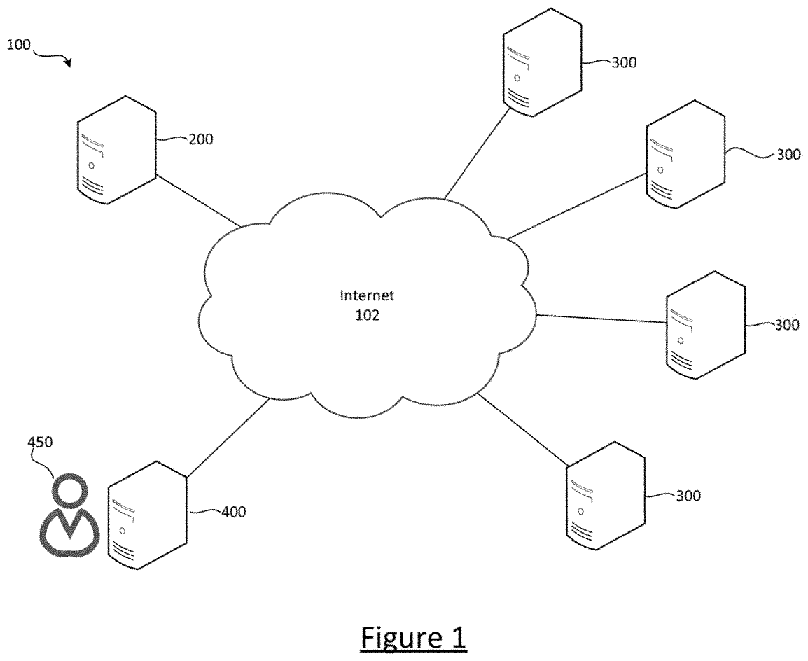

FIG. 1 is a system diagram showing an embodiment of the present disclosure. The diagram shows a networked system 100 comprising a number of computing devices 200, 300, 400 all configured to communicate over the Internet 102. A content ranking device 200 is configured to receive data from at least one data server 300. Preferably, there is a plurality of data servers 300. A user 450 can communicate with the content ranking device 200 through use of the user device 400. The user device 400 is configured to generate requests of the content ranking device 200 and receive ranked content.

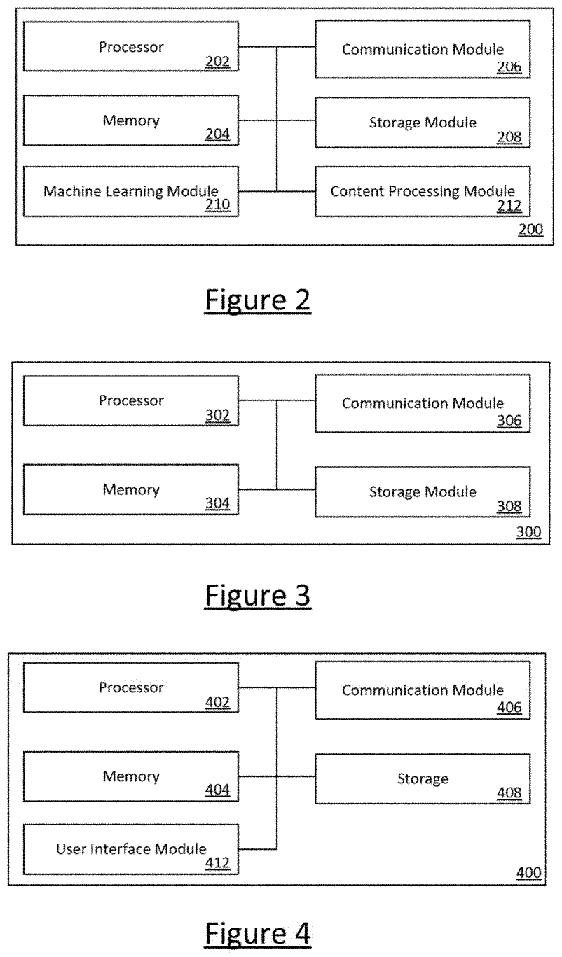

The content ranking device 200, described in greater detail with reference to FIG. 2, is configured to receive and rank content items. For this example and others, the type of content item(s) being processed are text-based articles. A person skilled in the art will appreciate that other types of content item may similarly be used (and/or modified to be used) with the methods and systems described herein. Other content item types could include images, video, audio, and any combination of these content types. For example, if the content item is audio based, then a script can be obtained either through use of speech to text technology or already be pre-generated by the audio content provider. This way, the same text processing techniques can be applied.

The data server 300, described in greater detail with reference to FIG. 3, is configured to provide source data. Source data is indicative of content item(s) for the content ranking device 200 and preferably a plurality of articles as discussed below. The data server 300 may be a third-party news aggregator that provides data feeds (e.g. GDELT and Feedly), a Twitter feed, RSS feed, a darkweb forum, and/or a darkweb feed. A person skilled in the art will appreciate that content for classifying and ranking can be obtained from a plurality of different data sources across the Internet.

FIG. 2 illustrates a block diagram of one example implementation of the content ranking device 200 within which a set of instructions for causing the computing device to perform any one or more of the methodologies, processes and techniques discussed herein, may be executed. In the present example, the content ranking device 200 is connected via the Internet to other machines and servers. The content ranking device 200 may be any form of computing device, including a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Preferably, the content ranking device 200 is a server. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The content ranking device 200 includes a processor 202, a memory 204 (e.g., read-only memory (ROM), flash memory, random-access memory (RAM), dynamic random-access memory (DRAM) such as synchronous DRAM (SDRAM) and/or Rambus DRAM (RDRAM), etc.), a communications module 206 (e.g. an Ethernet interface, Wi-Fi module, etc.), a storage module 208 (e.g., any one or more of the following: flash memory, static random-access memory (SRAM), data storage device, database connection module, etc.), a machine learning module 210, and an article processing module 212; all which communicate with each other via a bus.

The processor 202 represents one or more general-purpose processors such as a microprocessor, central processing unit, or the like. More particularly, the processor 202 may be a complex instruction set computing (CISC) microprocessor, reduced instruction set computing (RISC) microprocessor, very long instruction word (VLIW) microprocessor, processor implementing other instruction sets, or processors implementing a combination of instruction sets.

The processor 202 may also be one or more special-purpose processing devices such as an application specific integrated circuit (ASIC), a field programmable gate array (FPGA), a digital signal processor (DSP), network processor, or the like. The processor 202 is configured to execute the processing logic (instructions) for performing the operations and steps discussed herein.

The communication module 206 is configured to establish and maintain connections to other computing devices. The communication module 206 comprises hardware (such as a physical Ethernet interface) and software to establish the connections (such as Ethernet firmware). The communication module 206 can comprise one or more interfaces (e.g. an interface to the Internet, an interface to a LAN, or an interface to a system bus within the computing device). The communication module 206 can comprise a wireless network interface or a wired network interface. In the present example, the connections are made over the Internet. The communication module is configured to establish a TCP/IP connection, via a router, to the other computing devices. It will be appreciated that other networking protocols and/or hardware can also be used.

The storage module 208 may include one or more machine-readable storage media (or more specifically one or more non-transitory computer-readable storage media) on which is stored one or more sets of instructions embodying any one or more of the methodologies or functions described herein. The instructions may also reside, completely or at least partially, within the memory 204 and/or within the processor 202 during execution thereof by the content ranking device 200, the memory 204 and the processor 202 also constituting computer-readable storage media.

The storage module 208 may further comprise a database and/or means to connect to a database. The database may be stored physically on the same computing device or on a separate computing device. When the database is located on a separate device, the storage module 208 is configured to access it via the communication module 206.

The machine learning module 210 comprises hardware and/or software configured to conduct machine learning model training and inference based on the trained machine learning model(s).

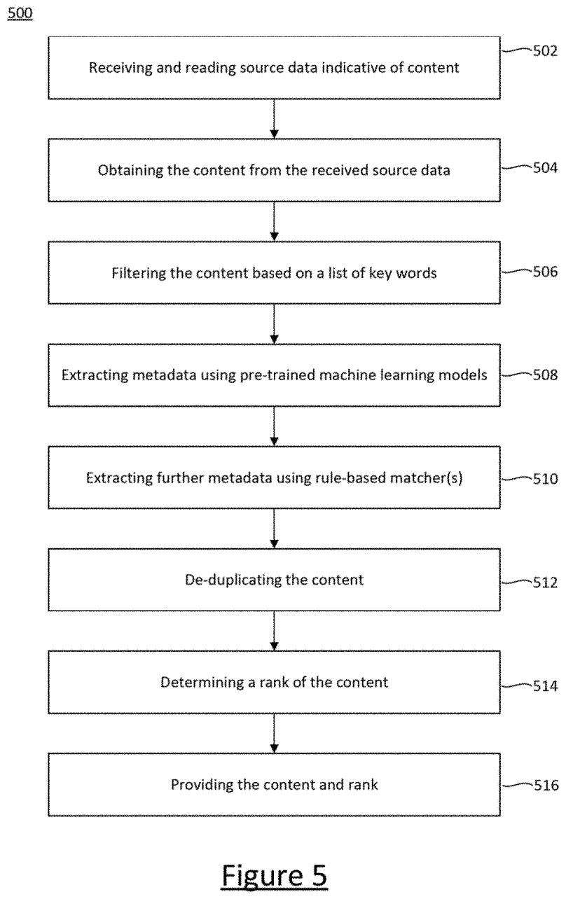

The content processing module 212 comprises hardware and/or software configured to coordinate a number of processes related to the content item classification and content item ranking as described herein. Preferably, the content processing module 212 is configured to run the method 500 as described with reference to FIG. 5.

Referring to FIG. 3, a data server 300 is shown. The data server 300 comprises similar or the same modules as the content ranking device 200. Similar reference numerals and labels have been used between the FIG. 2 and FIG. 3 to show modules that are configured to operate in a similar way. Differences of operation or composition are outlined below.

The storage module 308 of the data server 300 is configured to store source data for the content ranking device 200. Optionally, the storage module 308 further stores the article itself. Alternatively, the storage module 308 stores a reference to the article and the article is stored on a different storage module or server. The reference to the article may be stored as a URI (Uniform Resource Identifier). Preferably, the reference to the article is stored as a URL (Uniform Resource Locator).

The data server 300 is configured to provide the source data in a consistent format. If multiple data servers are present, then each data server may have its own format. The standard format may be any one of the following: JSON, XML, CSV, RSS, or any other known formats. By way of example, below are two different example data formats used by data servers. The content ranking device 200 is configured to read either format (and more) to extract the appropriate fields for further processing.

A data server 300 configured to provide GDELT™ data provides the source data in the CSV format with the following fields: GKGRECORDID, DATE, SourceCollectionldentifier, SourceCommonName, DocumentIdentifier, Counts, V2Counts, Themes, V2Themes, Locations, V2Locations, Persons, V2Persons, Organizations, V2Organizations, V2Tone, Dates, GCAM, SharingImage, RelatedImages, SocialImageEmbeds, SocialVideoEmbeds, Quotations, AllNames, Amounts, TranslationInfo, Extras.

A data server 300 configured to provide Feedly™ data provides the data in the JSON format according to the following layout immediately below. In this example, the data is an array of JSON objects where each object represents and contains a content item (in particular an HTML text-based article). Alternatively, the source data may comprise only a single JSON object with one article.

```
[ {
  “id”: “ . . . ” ,
  “originId”: “ . . . ” ,
  “fingerprint”: “ . . . ” ,
  “language”: “ . . . ” ,
  “content”: “ . . . ” ,
  “title”: “ . . . ” ,
  “crawled”: “ . . . ” ,
  “origin”: “ . . . ” ,
  “summary”: “ . . . ” ,
  “alternate”: “ . . . ” ,
  “published”: “ . . . ” ,
  “visual”: “ . . . ” ,
  “canonicalUrl”: “ . . . ” ,
  “unread”: “ . . . ” ,
  “categories”: “ . . . ” ,
  “commonTopics”: “ . . . ” ,
  “entities”: “ . . . ” ,
  “leoSummary”: “ . . . ” ,
  “estimatedCVSS”: “ . . . ” ,
  “engagement”: “ . . . ” ,
  “engagementRate”: “ . . . ”
} , { . . . } ]
```

In this example, the Feedly source data comprises the “content” and “canonicalUrl” members. As such, the Feedly source data comprises both the content item itself (in the form of an article) and a reference to the content item. The GDELT data does not comprise the content item itself and only a reference to the content item under the “DocumentIdentifier” field.

Referring to FIG. 4, a user device 400 is shown. The user device 400 comprises similar or the same modules as the content ranking device 200. Similar reference numerals have been used between the two figures and thus are configured to operate in a similar way. Differences of operation or composition are be outlined.

The user device 400 is configured for use by a user 450 to review the ranked content items after they have been processed by the content ranking device 200. The user device 400 is also configured to generate and transmit a query to the content ranking device 200 to request ranked content items. The user device 400 further comprises a user interface module 414. The type of user interface module 414 or modules used depend on the specific type of user device. The user device may be a smartphone or a tablet and, in this case, the user interface module 414 comprises a touchscreen interface. Alternatively, the user device 400 is a laptop or PC, and, in this case, the user interface module 414 comprises a monitor, keyboard, and mouse.

Content Classification and Ranking

Referring to FIG. 5, a method 500 of classifying and ranking content items is shown. The content ranking device 200 is configured to run the method 500. While the steps 502, 504, 506, 508, 510, 512, 514, 516 are presented as a sequential set of steps, some of the steps may be conducted separately, at a different frequency, asynchronously, and/or in a different order than shown. Further, some steps may be omitted and the method 500 may still be able to classify and rank the content items. While specific reference is made in the description of method 500 to the content ranking device 200 and data server(s) 300, this is by way of example only.

In the first step 502, source data is received and read. The source data is received from a data server 300. The source data describes a plurality of content items. The reading of the source data is conducted using a data source specific reader. The data source specific readers are configured to take the data from different sources and standardise it to one format for further processing. One data source specific reader is used per data server 300 or alternatively one data source specific reader is used per format provided by the data servers. Preferably, the standardised format comprises the fields: title, id, date, source, url, entities, and image (s). Any extra data fields in the source data are discarded and not used in any further steps. Alternatively, any data in the extra data fields is stored alongside the standardised format in a feed specific data field. Optionally, if the content item itself is present in the source data, the content item is also stored.

The data source specific reader comprises information on how frequently to obtain source data from the data server 300 it is configured to read from. New content items are obtained between every 5 minutes and every hour, preferably between 10 minutes and 45 minutes, and even more preferably between 12 minutes and 30 minutes, and yet still more preferably every 15 minutes.

To receive the source data in step 502, the content ranking device 200 is configured to connect with the data server 300 via the Internet 102 and download the source data indicative of content items from the data server 300. Preferably, source data is obtained from multiple data servers 300.

In the second step 504, the content items themselves are obtained based on the source data. Depending on the format of the source data obtained from the data server 300, the source data may comprise the content item itself and/or the source data comprises a reference to the content.

Where the source data already comprises the content item, the content item is read from the source data and stored for further processing. Where the source data contains a reference to the content item, the reference is followed and the content item is obtained. Preferably the reference is in the form of a URI and more preferably a URL and the content item is an HTML based web page at the URL. The URL is followed and the HTML content located at the URL is scraped using a web scraper. The web scraper may be further configured to download any CSS and/or Javascript associated with the content so that the look and feel of the content is preserved. Optionally, the web scraper comprises a Javascript engine to run any Javascript that may be necessary to load the web page.

As mentioned above, the content items are obtained and stored for later use. This allows the steps of receiving the source data and content scraping to be run asynchronously to the remainder of the content processing. Thus, when the content items have already been received, the obtaining step 504 is conducted by recalling the content items from a storage.

With the content items obtained, they are optionally filtered based on a list of key words in the next step 506. In this example, the only content that is of interest is cyber related news articles. As such, a pre-defined set of cyber related key words are used. For example, the following words are used: “security”, “breach”, “hack”, “cryptocurrency”, “WannaCry”, etc. If an individual content item does not contain any of these key words then the content item is immediately excluded from being processed any further. Compared to the other content item processing steps in this method, this is a computationally low-cost operation. By conducting this low-cost operation earlier on in the pipeline, it reduces the time and resources used to process a given number of content items.

The set of key words is preferably updated by a domain expert periodically to ensure that new content items are correctly filtered.

Alternative or in addition to the filtering step 506, the key words may be used during the receiving and reading step 502 when communicating with the data server 300 such that only content items which relate to the key words provided are received in step 502.

After filtering out irrelevant content items, metadata for each content item is extracted 508. The metadata extracted comprises at least one classification of the content item. The classifications are extracted using a machine learning classification process or processes. The classification process is a predictive modelling process that involves assigning a classification or classifications to an input. The input in this context is the content item. Each content item goes through this machine learning classification process such that the content items are classified into a number of different classifications. The machine learning models can also be considered “machine learning classifiers”. A number of machine learning models are used for different classifications. A content item can be classified into any one or more of the following classifications: industry classification, size classification, incident classification, attack type classification, and data type classification. Preferably all of these classifications are used.

The industry classification provides an indication as to what industry the content item relates to; examples include the finance industry, engineering industry, legal industry, payment card industry (PCI) etc. The size classification provides an indication as to the size of the company or attack the content item relates to; examples include a micro entity, small entity, medium entity, or large entity. The incident classification provides an indication as to whether the content item relates to a particular incident (such as breaking news content describing a new event) or not. The attack type classification provides an indication as the type of attack the content item relates to; examples include a data breach, hack, phishing attach, randsomware attack, etc. The data type classification provides an indication as to what type of data the content item relates to; examples include Personally Identifiable Information (PII), payment card information, password dump, trade secrets.

It is possible that a content item may be classified as relating to more than just one classification within the same classification type. For example, a content item might relate to both the finance industry and the legal industry, or the attack type classification may show that the content item relates to both phishing and randsomware attack types if the content item described an event where a phishing attack was used to start a randsomware attack.

The classification process outputs a probability that the content has that classification or not. The probability is usually provided from 0 to 1 where 0 means the content definitely does not belong to that class and 1 where the content definitely does belong to that class. A high probability that a content item relates to a given classification may be when the probability is between 0.75 and 1.

By way of an example, taking a content item that describes the 2017 Equifax™ data breach and applying the classification models would result in the following classification probabilities:
for the industry classification: high probability of financial industry, high probability of Payment Card Industry (PCI), and low probability for all others;
for the size classification: high probability of large enterprise, and low probability for all others;
for the incident classification: high probability of incident-related article;
for the attack type classification: high probability of data breach, and low probability for all others; and
for the data type classification: high probability of both Personally Identifiable Information (PII) and payment card information, and low probability for all others.

The classifications made by the machine learning models as described herein work together to provide an improved way to sort and rank content by relevancy according to a provided or pre-generated query. The query may be generated by a user and based on their interests and therefore the content items are ranked according to their interests. A user query (described below) is thus able to act on classifications of the content, rather than simple key word text searching. Basing a ranking on classified content provides technical advantages over simple key-word solutions. This technical improvement enables content items of interest to be found and presented in a logical and efficient manner. In particular, and if compared with a generic search engine, a user does not need to provide all the different key words that may or may not relate to the classifications they are wanting to filter by. This saves time for the end user and computing resources at the user device by reducing the reading, understanding, processing, and filtering.

Further, classifications discussed above have been selected to synergistically allow for better ranking opportunities (and therefore all the other advantages as described above associate with improved ranking). The classification types are selected such that the ranking (based on the classification types and user query) provides useful insights and appropriate reduction in content size and scope to more manageable levels. The reduction in total amount of content has further advantages by reducing computing resources used as they won't be wasted on low ranked, and thus less (or not) relevant content.

The machine learning models used are trained prior to them being used in this step 508 or the operation of this method 500.

Other metadata extracted comprises a summary of the content item. The summary is extracted using a machine learning model.

Optionally, any one or more of the following metadata are additionally extracted: key words, sentiment, date, location, author, and length.

In the next step 510, rule-based matcher(s) is/are used to extract further metadata from each content item. Preferably a plurality of rule-based matchers are used to extract more metadata. The rule-based matchers comprise linguistic rule(s) and are configured to operate on the text of the content items. Optionally, the linguistic rules describe rules that operate on tokenised text. Where tokenised text is used, the present step 510 tokenises the text before applying the linguistic rules. Example rule-based matchers include:
a. Vulnerability: A rule-based matcher looking for mentions of recently disclosed security vulnerabilities. Example of rules for the matching include:
   i. “Critical”+[word(s) in between]+“vulnerability”
   ii. “Severe”+[word(s) in between]+“exploit”
   iii. “Zero-day”
b. Threat-Actor: A rule-based matcher looking for mentions of different cybercriminal groups. Example of rules for the matching include:
   i. “Nation state threat actor”
   ii. “Hack-for-hire”/“cyber-mercenary” “group”
   iii. “APT”
c. Entity-Event: A rule-based matcher looking for mentions of one or more entities along with one or more cyber-attack keywords. Examples:
   i. “Microsoft Corporation” & “ransomware”
   ii. “Amazon Web Services” & “outage”

The rule-based matcher is implemented using spaCy's™ rule-based matchers. To match the first vulnerability text (referenced as “a. i.” above), an example spaCy rule-based matcher would look like:
[‘LOWER’: ‘critical’}, { }, {‘LOWER’: ‘vulnerability’}]

Where the { }′ (an empty dictionary) is a wildcard matcher.

Alternatively, the rule based matcher is implemented using regular expressions. To match the first vulnerability text (“a. i.”), an example regular expression implemented rule-based matcher may look like:
(?i)\bcritical\b(.*)\bvulnerability\b

These rule-based matches provide further ways for users to filter and rank content. Filtering, as discussed with reference to the previous filtering step 506 is an efficient way to remove irrelevant content. Thus, similar advantages as with the other filtering step also apply here. Additionally, or alternatively, the rule-based matches can provide further classification information in that they classify the content items and thus the advantages provided by classification are similar here. The advantages of this metadata extraction become more apparent when it comes to providing the ranked content. The volume of content items provided will be reduced and more focused on the received request.

As content items and source data are collected from multiple data servers 300, there is a chance that the same content or nearly the same content is received, read, and processed multiple times. This can occur because two different data servers 300 reference the same content, or because a piece of content is copied/plagiarised and uploaded elsewhere. In this next step 512, the duplicate content items are removed (this process is also known as de-duplication).

Removing of duplicate content items is based on the content of the content item. For example, the text within each content item. Each content item is compared with each other content item and if the content items are similar enough, all but one is removed from further processing. Text similarity systems are used to compare content items that are primarily text based. Example text similarity systems and algorithms include the Levenshtein distance, Locality-sensitive hashing, and Cosine similarity.

At this stage, the processed content items and associated generated metadata (such as classifications and rule-based matched terms) is optionally stored for later access. The collection of processed content items and associated generated metadata is added to every time the more content items are collected.

A rank is determined for processed content items in the next step 514. The rank is based on any of the previously determined metadata. Preferably, the rank is based on any one or more of the following: industry classification, size classification, incident classification, attack type classification, and data type classification. Optionally, the rank is based on a time related factor such that more recent content has a higher rank. Preferably, the rank is based on a combination of those classifications. More preferably it is based on at least the industry classification, the size classification, and the incident classification. Even more preferably, the rank is based on a combination of all of industry classification, size classification, incident classification, attack type classification, and data type classifications. Most preferably, the rank is determined using the equation immediately below.

$$Rank = ( {W}_{i} \times Industry Classification Probability + {W}_{s} \times Size Classification Probability ) \times Recency Decay Factor \times Incident Boosting Factor \times Attack Type Boosting Factor \times Data Type Boosting Factor$$

Each of the classifications, when used to determine the rank, have an associated weight. Weights are used to determine how important that feature is to the final ranking score. The weights are determined by domain experts. Advantageously, by using domain experts to determine the weighting, an end user using the ranking system described herein can take advantage of an expert's knowledge in filtering and classification without having the knowledge themselves. The weights can also be considered a boosting factor as they can boost up the final rank value.

The rank is based on the incident classification such that content relating to a breaking news event or incident will give a higher rank. This allows a user to be able to control whether they want news to be ranked higher over general/background articles. This extra option for tuning the ranking allows for greater control of content items and therefore a better end user experience. It reduces the time an end user must take in filtering and sorting through content that is not relevant or important them manually. By way of example, if a user is a news reporter, they are likely only interested in incidents and as such tuning the incident boosting factor to heavily improve the rank for only incidents provides them with content items they are interested in thereby saving the user time and resources.

The Recency Decay Factor is a factor that will reduce the rank of older articles with different parameters to control how fast older articles will decay in their ranking score. This can be used if a user is interested in only recent articles.

The Incident Boosting Factor is a determined according to the equation below where Wₐ is the weight and the weight is a number between 0 and 1.

Incident Boosting Factor=1+W_{c}×Incident Classification Probability

The rank is based on the attack type classification such that content relating to a specific, user specified attack type will give a higher rank. For example, if a user is only interested in randsomware attacks, the rank will be higher if the content is classified as relating to randsomware attacks. An indicator value is used for when a user is not interested in filtering by attack type classification. The indicator value is 0 or 1, 0 if the rank is not to be modified by the attack type classification and 1 if the rank is to be modified by the attack type classification.

The Attack Type Boosting Factor is determined according to the equation below where Wₐ is the weight and the weight is a number between 0 and 1. Iₐ is the indicator value.

Attack Type Boosting Factor=1+Iₐ×Wₐ×Attack Type Classification Probability

The rank is based on the data type classification such that content relating to a specific, user specified data type will give a higher rank. For example, if a user is only interested in medical data related content items, the rank will be higher if the content is classified as relating to medical data. An indicator value is used as with the attack type for when a user is not interested in filtering by data type classification.

The Data Type Boosting Factor is determined according to the equation below where W_{d} is the weight and the weight is a number between 0 and 1. I_{d} is the indicator value.

Data Type Boosting Factor=1+I_{d}×W_{d}×Data Type Classification Probability

By way of example, if request for content relating to large healthcare enterprises (i.e. large hospitals) is received, then the content items will be ranked with respect to the probability that the industry is healthcare and the size is large. In this example domain experts have set the Wᵢ=0.66 and Wₛ=0.33 such that when the content items are ranked with respect to the probability of the industry being healthcare and the size being large while the contribution of industry classification (healthcare) is twice more as the on from the size classification (large) to the final rank.

Processing of content that is ranked according to the method 500 described with reference to FIG. 5 can result in an increase in time and resource efficiency compared with processing unranked data. One example system to save time and resources is to compare the rank to a threshold rank value. If the rank is not sufficiently high (i.e. not higher than the threshold value) then it will not be further processed or provided to the end user. For example, if the content is going to be fed into an Internet based content distribution system, then if the rank isn't high enough, the data will not be distributed. Thus saving on Internet bandwidth, saving storage space on a content distribution server, saving storage space on the end users of the content distribution system, and other computer resources.

In another example, if a device receives ranked content then that device can be configured to behave differently depending on the rank. The receiving device may optionally prioritise processing of higher rank content thus enabling more relevant and interesting content to be processed and arrive to the content's ultimate consumer first.

A rank may also be used in combination with a caching system. Higher ranked content is likely to be access more and thus would benefit from being cached.

By processing the data according to the method 500 described with reference FIG. 5 and focusing on cyber related news articles specifically the scope of filter steps and data processing required when compared with other general-purpose content processing prior art systems is reduced. Reduction in scope advantageously results in a reduction of computing resources required. Only five different classification models are used and while they are multi-label classifiers, compared with a general purpose ranking and/or classification system (if such a system were to possibly exist), the limitation to only cyber-related article classifications as has been described advantageously means computing resources required to process and provide said content will be lower. This is particularly relevant for machine learning models and techniques as these can, depending on input data, be extremely processor and/or memory intensive tasks.

The specific classifications described herein are advantageously selected to provide useful features for content items to be ranked on. The classifications are selected to allow a user, who may not have expert domain knowledge in the field of cyber-related events, to provide or select a query for the content ranking device 200. The query will comprise useful information that allows the content ranking device 200 to appropriately rank and provide content items to a user device. By limiting the scope of query options to only those that will be useful to the ranking system, the total query possibilities are reduced and therefore computer resources are saved while still providing useful ranking.

With the rank determined, the content items are provided 516 to an end user in a number of ways. The content items are preferably provided with the rank. Providing the content items with their rank allows the final consumer of the content to decide how to display, sort, order, filter or otherwise process them. Optionally, the content items are ordered according to their associated rank. Alternatively, the content items are provided in order of rank and without their rank. This alternative method allows the rank determined to be hidden from the user thus at least partially obfuscating how the rank is determined.

Different uses for the rank are described below. These different uses for the rank preferably use the rank as determined using the method described above, or alternatively a different ranking method. Further, the different example uses for the rank undertake the rank calculation step at different times.

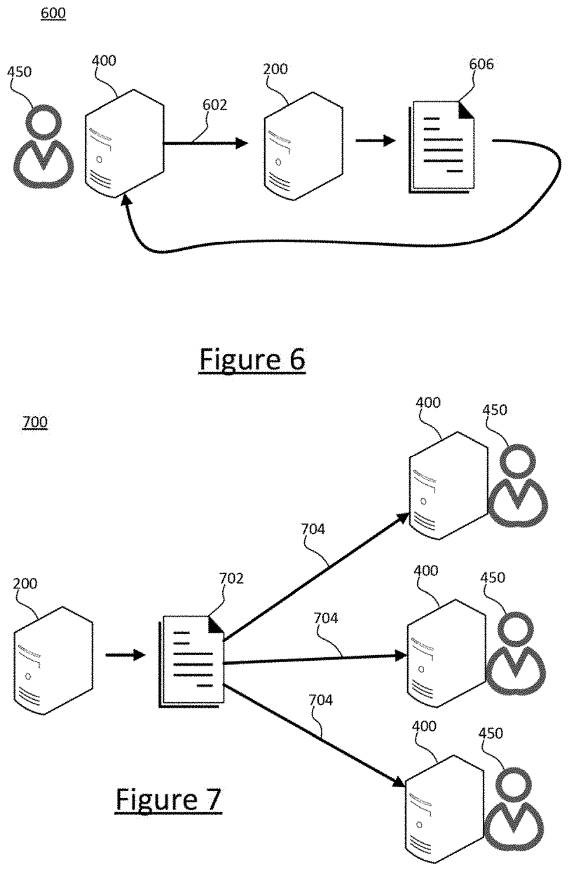

The ranking step 514 can be run asynchronously to the preceding steps. Preferably the ranking step is done when a request is received to calculate a rank. The request to calculate ranking(s) is preferably from a user device. One example embodiment of this is the “Query Based News Feed” described with reference to FIG. 6. The user request comprises factors that go into the ranking. These factors can be any one or more of the following: any classification(s) they are interested in, key words or phrases and any other feature of the content items described herein. The user request may comprise other factors may also affect the ranking.

The user request may comprise features relating to the terms extracted by the rule-based matchers. The rule-based matched terms act as a filter such that content items that do not relate to rule-based matches will not be delivered thereby saving computing resources. As an example, a request for content items related to retail stories that involve threat-actor rules is received. The ranking step ranks the content items according to relevance to the retail industry and those content items are then filtered such that only items that comprise terms the threat-actor rules extracted are provided. Optionally, the filtering step is done before the ranking step. It may be more energy efficient to conduct a “are the matched rules present?” check than to undertake the ranking step. Conducting lower computationally intensive checks earlier to filter content, as described above, results in a saving of computing resources.

Alternatively, the ranking step is conducted on a periodic basis. This way, the ranking step is conducted with no input from a user device. As a further alternative, the ranking step is conducted when a certain amount of content items have been processed. In these alternative examples, pre-defined classifications, weights, key words, phrases and/or any other feature of the content items are used to base the ranking on.

Query Based News Feed

Referring to FIG. 6, an illustration of an embodiment of the present disclosure is shown. The illustration shows a system 600 for querying, ranking, and receiving content. A user 450, through use of a user device 400, generates and transmits a user query 602 to a content ranking server 200.

The content ranking server 200 receives the query 602. The query 602 comprises information regarding the content that the user 450 is interested in. The query 602 comprises a number of filters such that the content items provided to the user are only relevant to those filters. In this example embodiment, the filters are classifications of the content items. The user query 602 can also be described as comprising classifications the user is interested in. The classifications of the user query 602 substantially match the classifications already determined by the content ranking server 200 according to the method 500 described herein. Preferably, the industry and size classifications are included in the user query 602 and the other classifications are optionally included. These user query classifications are used in the ranking step as described in step 514 of the method 500 described with reference to FIG. 5.

The user query 602 optionally comprises further filtering options. Preferably the further filtering options are based on any one or more of the metadata types extracted according to method 500. Example further filtering options include any one or more of the following: summary, key words, sentiment, date, location, author, and length.

With the user query 602 processed and ranking completed, the content ranking server 200 provides the ranked content 606 to the user 450. The ranked content 606 is transmitted to the user device 400.

Email-Based Newsletter

Referring to FIG. 7, an illustration of an embodiment of the present disclosure is shown. The figure shows system 700 where an email-based newsletter 702 is generated and distributed 704 to a number of user devices 400. End users 450 review the content on their user devices 400.

Similar to the Query Based News Feed described with reference to FIG. 6, the Email-based Newsletter system comprises a number of pre-defined queries that users are able to subscribe to. The pre-defined queries comprise the same or similar filters and/or classifications that are described with reference to the queries 602 of the example in FIG. 6. Periodically, newsletters 702 are generated by the content ranking server 200. The newsletters 702 comprise ranked content according to the pre-defined queries. The newsletters 702 are transmitted 704 to whichever user devices 400 based on whether the user 450 has subscribed to them. The newsletters are preferably emailed. The newsletters are generated monthly, weekly, and/or daily.

Machine Learning Model and Model Training

As discussed in the method 500 described in FIG. 5, machine learning models are used. These machine learning models are pre-trained.

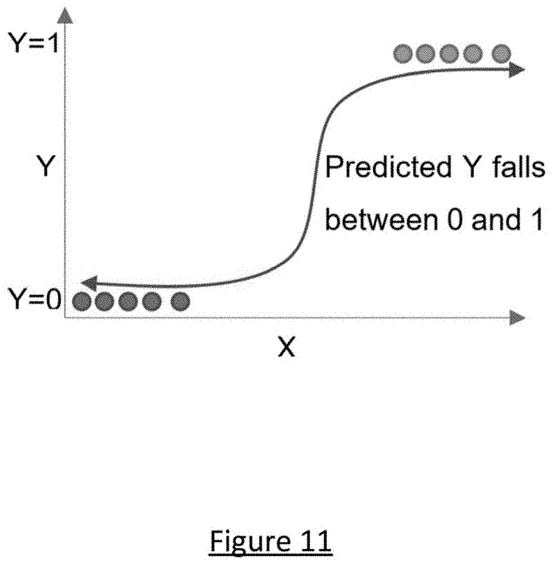

The machine learning models use logistic regression. The classification model y=f(x) can be written as

$$P ( {y}_{d} = 1 \vert {x}_{d} ) = \frac{1}{( 1 + {e}^{- {w}^{T} {x}_{d}} )}$$

where x_{d} is the feature vector for article d, y_{d} is the class label, and w^{T} is the transposed vector of coefficients for the corresponding features. A feature here is a token, unigram, and/or bigram of the “controlled vocabulary” as described below. The diagram of FIG. 11 indicates how logistic regression can be used as a classification model. Logistic regression is fit by iteratively minimizing the error between the estimated and true labels. An alternative for fitting logistic regression is called gradient decent.

Optionally, the machine learning models are pre-trained according to the methods described below. In the training phase, a bag-of-words feature representation from each a set of training content is generated. The bag-of-words are extracted as unigrams and bigrams. With the training data tokenized into unigrams and bigrams, stopwords are removed and the tokens are stemmed. The stemming is conducted using the Porter stemmer algorithm. Alternatively, other stemmers are used. A controlled vocabulary is constructed based on the stemmed tokens. The controlled vocabulary is constructed based on two feature selection methods: the Chi-squared, and information gain. Preferably, the controlled vocabulary is constructed based on the union of the two feature selection methods. Finally, a weighting is applied to the tokens to identify which tokens are of greater importance. Preferably, TF-IDF is used to weight the importance of the tokens.

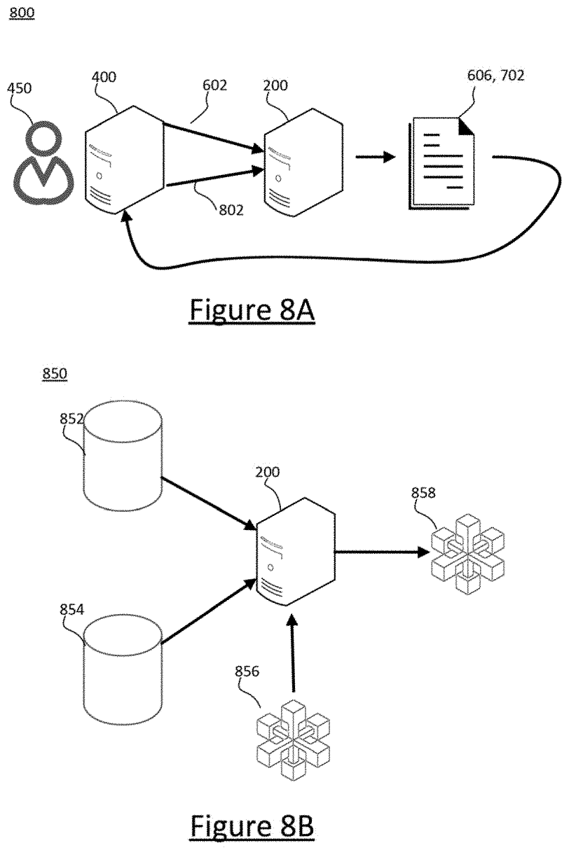

Preferably, the machine learning models are updated periodically. For example, if the first models were trained on 10,000 content items that were available at the time, six months later, when another 10,000 new content items are available, the training is re-run on the 20,000 content items in total. This approach advantageously ensures that the models are up to date with newer trends in the content as well as improving the model fits by virtue of having more training data available. The machine learning models are preferably updated based on user feedback and usage of the content and metadata generated. Referring to FIG. 8A, a system 800 for receiving feedback and updating the ranking model is shown. As an addition to the Query Based News Feed and/or the Email-based Newsletter described with reference to FIGS. 6 and 7, the user's interaction with the content once it has been delivered to the user device 400 is tracked. Alternative to periodic updates, the machine learning models are updated while the content ranking system is running. This alternative training technique can be called “online” training.

FIG. 8B shows a similar system 850 to the one described in FIG. 8A where the feedback has already been collected and stored in a database 852. Previously processed content is also stored in a database 854. Optionally the database 854 is part of the content ranking server's storage module 208. In this system 850, the current machine learning model (or models) 856 is also used. This machine learning model 856 is depicted as a separate component for illustrative purposes only and the machine learning model 856 is stored on the content ranking device 200 and preferably in the content ranking device's machine learning module 210.

Once a new model has been generated and/or the current model has been updated based on the feedback provided, at least a subsection of the old content is re-classified and processed using the new machine learning models. This way, future user requests that want to include content from the past will benefit from any improvements made presently.

Cyber Index

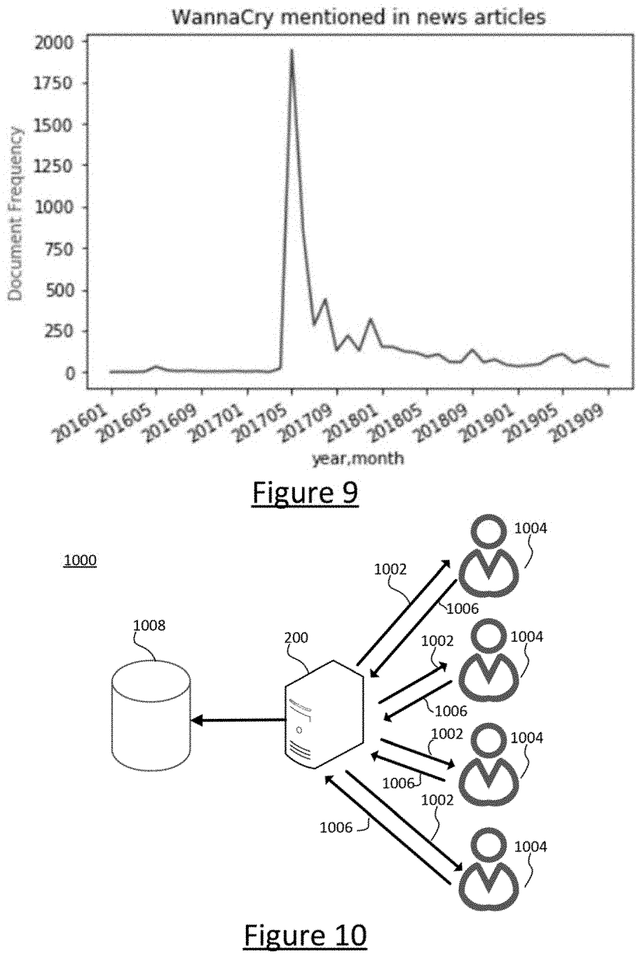

Referring to FIG. 9, a chart of WannaCry mentions in new articles across time is shown. This information can be tracked using an entity-event rule-based as described with reference to step 510. For this WannaCry example, rule-based matchers that matched at least against the word “WannaCry” and “Wannacry” were used. An example spaCy implementation to match this would be:
[{‘LOWER’: ‘wannacry”}]

With the above rule-based matcher, the chart of FIG. 9 is generated by tracking the number of articles in which this matcher successfully finds a match. This chart was generated on historical content items as well as current content items. A historical content item can used as long as the publication date of the content item is known.

With this information, analysis and identification of potentially catastrophic events are possible. The larger the increase in mentions, the bigger the event is. This process of identifying and analysing the size of the event is used in the ranking step described herein. The event size is a further classification that may be used to base the rank on. For the example shown in FIG. 9, the sharp increase in article mentioning WannaCry ransomware shows that the event occurred in mid-May 2017 and that it was a catastrophic and large event.

Extraction and Curation of Cyber Incidents

Referring to FIG. 10, a system 1000 for identifying and storing incidents. In this system 1000, a draft incident is identified by the content ranking device 200. A draft incident may be identified according the method as described with reference to FIG. 9. Alternatively, a draft incident is identified by a domain expert. With a draft incident identified, all content items relating to the draft incident is processed and has its metadata extracted as described with reference to the metadata extraction steps 508, 510 in the method 500 of FIG. 5 above.

With the metadata extracted, it is then sent 1002 to a random selection of domain experts 1004. These domain experts then review the extracted metadata and provide corrections and/or further suggestions of the metadata. Preferably, the domain experts are correcting, confirming and/or creating new classifications of the intendent. Optionally, the content items are also sent to the domain experts so that classification of each content item can be conducted too.

The corrections to, confirmations of, and new classifications are sent 1006 back to the content ranking device 200. The content ranking device 200 is configured to collate all of the received metadata and find a consensus. The draft incident has the new collated metadata applied to it and the draft incident moves to be a confirmed incident. The confirmed incident is stored on a database server 1008 operatively coupled to the content ranking device 200. Alternatively, if no consensus is arrived at and/or the experts provide classifications that suggest there isn't an incident, then the draft incident is removed.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid-state memory, magnetic tape, a removable computer diskette, a random-access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” or “hardware module” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” or “hardware module” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “determining”, “providing”, “calculating”, “computing,” “identifying”, “combining”, “establishing”, “sending”, “receiving”, “storing”, “estimating”, “checking”, “obtaining” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein the term “and/or” means “and” or “or”, or both.

As used herein “(s)” following a noun means the plural and/or singular forms of the noun. The singular reference of an element does not exclude the plural reference of such elements and vice-versa.

It is to be understood that the above description is intended to be illustrative, and not restrictive. Many other implementations will be apparent to those of skill in the art upon reading and understanding the above description. Although the disclosure has been described with reference to specific example implementations, it will be recognized that the disclosure is not limited to the implementations described but can be practiced with modification and alteration within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A computer implemented method for data processing and/or analysis, the method comprising the steps of:
obtaining a plurality of content items,
obtaining metadata from each of the content items, wherein the metadata comprises at least one classification of the content items,
determining a rank of each content item based on at least the obtained metadata of the content item, and
transmitting at least a subset of the ranked content items.

2. A computer implemented method according to claim 1, wherein the step of obtaining the metadata for each of the content items comprises classifying the content item using at least one classification model.

3. A computer implemented method according to claim 2, wherein the at least one classification model is any one or more of the following: an industry model, a size model, incident type model, and a data type model.

4. A computer implemented method according to claim 2, wherein the at least classification model is a pre-trained machine learning model.

5. A computer implemented method according to any claim 1, wherein the rank is based at least in part on the at least one classification.

6. A computer implemented method according to claim 5, wherein the at least one classification is any one or more of the following classifications: industry classification, size classification, incident classification, attack type classification, and data type classification.

7. A computer implemented method according to claim 6, wherein the rank is based on at least in part any one or more of the following: industry classification, size classification, incident classification, attack type classification, and data type classification.

8. A computer implemented method according to claim 7, wherein the rank is based on at least in part on the industry classification combined with an industry classification weight, the size classification combined with a size classification weight, the incident classification combined with an incident classification weight, the attack type classification combined with an attack classification weight, and the data type classification combined with a data classification weight.

9. A computer implemented method according to claim 8, wherein the rank can be selectively based on the incident classification, attack type classification, and data type classification.

10. A computer implemented method according to claim 1, wherein the rank is based at least in part on the age of the content item.

11. A computer implemented method according to claim 10, wherein the rank is higher if the content item is newer.

12. A computer implemented method according to claim 1, further comprising the steps:
receiving source data, wherein the source data is indicative of each content item,
filtering content items based on a list of key words, and
removing duplicate content items.

13. A computer implemented method for data processing and/or analysis, the method comprising the steps of:
receiving source data, wherein the source data is indicative of at least one content item,
obtaining a plurality of content items,
filtering content items based on a list of key words
removing duplicate content items,
determining a rank of each content item, and
transmitting at least a subset of the ranked content items.

14. A computer implemented method according to claim 13, wherein each key word in the list of key words is searched for in the content item.

15. A computer implemented method according to claim 14, wherein if none of the key words in the list of key words are found in the content item, the content item is removed from the plurality of content items and/or not further processed.

16. A computer implemented method according to claim 13, wherein the step of obtaining a plurality of content items is based on the source data.

17. A computer implemented method according to claim 16 wherein the step of obtaining a plurality of content items comprises the steps of:
obtaining a Uniform Resource Locator (URL) for each of the content items, and
obtaining data located at each URL, wherein the data located at each URL is the content item.

18. A computer implemented method according to claim 16 wherein the source data comprises the content item and the step of obtaining a plurality of content items comprises the step of obtaining the content item from the source data.

19. A computer implemented method according to claim 1, wherein the step of removing duplicates comprises the step of comparing each content item to each other content item and if each content item is similar enough then at least one of the content items is removed from further processing.

20. A computer implemented method according to claim 1, further comprising the steps:
extracting terms using at least one rule-based matcher.

21. A computer implemented method according to claim 20, wherein the at least one rule-based matcher is configured to identify at least one linguistic pattern using a linguistic rule.

22. A computer implemented method according to claim 21, wherein the content item comprises text, the text is tokenized, and the at least one rule-based matcher is configured to operate on the tokens of the text.

23. A computer implemented method according to claim 20, wherein the at least one rule-based matcher is configured to match then extract content relating to any one or more of the following: vulnerability, threat-actor, and entity-event.

24. A computer implemented method according to claim 20, further comprising the step:
filtering content items based on the terms extracted from the at least one rule-based matcher.

25. A computer implemented method according to claim 1, further comprising the steps:
receiving end user feedback data, and
calibrating the determination of the rank based on the received end user feedback data.

26. A computer implemented method according to claim 1, further comprising the steps:
providing at least one content item and associated metadata to a plurality of users,
receiving further metadata from the users,
consolidating the further metadata, and
updating the metadata with the consolidated further metadata.

27. A computer implemented method according to claim 1, wherein the content items are articles.

28. A computer implemented method according to claim 1, wherein content items are text based.

29. A computer implemented method according to claim 1, wherein the content items are cyber news related articles.

30. A computer implemented method according to claim 1, wherein the content items have any one or more of the following types of content: text, audio, and video.

31. A non-transitory computer readable medium configured to store computer readable instructions, which when executed by one or more processors performs the method as claimed in claim 1.

32. A computing device, comprising:
memory for storing computer-readable instructions in the form of a program; and
at least one processor configured to execute the program to execute the method as claimed in claim 1.

33. A system comprising:
at least one data server configured to provide source data indicative of content items, and
a content ranking device according to claim 32.
